(19) United States
(12) Patent Application Publication
(10) Pub. No.: US 2002/0044295 A1
(43) Pub. Date: Apr. 18, 2002

(54) Printer device

(75) Inventor: Chiharu Tanaka, Tokyo (JP)

Correspondence Address: FRISHAUF, HOLTZ, GOODMAN &, LANGER & CHICK, PC, 767 THIRD AVENUE, 25TH FLOOR, NEW YORK, NY, 10017-2023, US

(73) Assignee: Olympus Optical Co., Ltd., Tokyo (JP)

(21) Appl. No.: 09/909,189

(22) Filed: Jul. 19, 2001

(30) Foreign Application Priority Data
Oct. 16, 2000 (JP) 2000-315725
Apr. 10, 2001 (JP) 2001-111725

(51) Int. Cl. B41B 1/00; G06F 15/00

(52) U.S. Cl. 358/1.13; 358/1.17

(57) ABSTRACT

A printer device includes a plurality of memory card slots, a printing/copying key, a printing key, a copying key, etc. When a user presses the printing/copying key, a selected picture frame (image information) is printed and copied substantially simultaneously. When the printing key is pressed, the selected picture frame is printed. When the copying key is pressed, the selected picture frame is copied. However, when the printing key and the copying key are continuously pressed without changing the picture frame, the picture frame selected in the preceding process is used in the subsequent process.

### BACKGROUND OF THE INVENTION

1. Field of the Invention

The present invention relates to a printer device capable of copying and printing image information.

2. Description of the Related Art

Recently, a printer device for printing image information stored in a storage medium, for example, an image file, etc. captured by an electronic camera, etc. and stored in a storage medium has been popularized. Some printer devices can be provided with a plurality of storage medium installation units (for example, a memory card slot, etc.) to allow an image file, etc. to be copied among the installed storage media.

For example, in the Japanese Patent Application No.9-83921, a digital image processing system is suggested. This system is provided with two types of storage media, that is, a memory card and an optical disk, and can print predetermined image data stored there, and can record the data stored in one storage medium which is a playback source medium in another storage medium.

Normally, such a printer device (containing the above mentioned digital image processing system) performs a copying process among the installed storage media at an instruction of a user to perform a copying process (copying operation), and performs a printing process at an instruction of a user to perform a printing process (printing operation).

The copying process is performed according to the image information specified by the user, and the printing process is performed according to the image information specified by the user.

However, although such a printer device can copy image information among the installed storage media, it cannot simultaneously perform printing and copying operations. That is, to allow the printer device to perform the copying and printing operations, the user has to specify one of the copying and printing operations, and specify again the other operation after the first specified operation has been completed. Additionally, each time an operation is specified, the image information also has to be specified again. Therefore, the instructions are to be performed twice, thereby taking a longer time due to double operations.

Furthermore, when a user instructs the printer device to perform one of the copying and printing operations, and then requests to also perform the other operation on the same image information, the user has to specify the image information again.

### SUMMARY OF THE INVENTION

The present invention has been developed to solve the above mentioned problems. The first object of the present invention is to provide a printer device capable of allowing a user to quickly and easily specify substantially simultaneous copying and printing operations. The second object of the present invention is to provide a printer device capable of allowing a user to specify one of the copying and printing operations and continuously the other without specifying again the same image information.

The printer device for copying and printing image information according to the first aspect of the present invention includes: an installation unit for installing a plurality of storage media; a first selection unit for selecting a first storage medium from among the plurality of storage media installed by the installation unit; a second selection unit for selecting arbitrary image information stored in the first storage medium selected by the first selection unit; a third selection unit for selecting one of a copying mode in which the image information is copied to a second storage medium different from the first storage medium and a printing mode in which the image information is printed; and a mode processing unit for processing the arbitrary image information selected by the second selection unit in the first mode selected by the third selection unit, and performing the process in the second mode according to the same image information as in the first mode if the second mode different from the first mode is selected after the process in the first mode is completed.

With the above mentioned configuration, the printer device can perform the process in the printing mode according to the image information processed in the copying mode, or can perform the process in the copying mode according to the image information processed in the printing mode. Therefore, the above mentioned second object can be attained. The image information includes, for example, information about captured image (captured frame image, etc.) obtained by capturing an image using an electronic camera, information about edited image obtained by performing an image process on a captured image, information about a generated image generated by a user, etc. newly from the beginning.

The printer device capable of installing a plurality of storage media according to the second aspect of the present invention includes: a first selection unit for selecting a predetermined storage medium from a plurality of installed storage media; a second selection unit for selecting predetermined image information from the image information stored in a first storage medium selected by the first selection unit; a printing unit for printing the predetermined image information selected by the second selection unit; a copying unit for copying the predetermined image information selected by the second selection unit to a second storage medium selected by the first selection unit; a switch unit for switching a mode into a printing mode in which the printing unit is driven, a copying mode in which the copying unit is driven, or a printing/copying mode in which the printing unit and the copying unit are substantially simultaneously driven; and a control unit for controlling the copying unit and the printing unit in the switched-to mode into which the switch unit has switched.

With the above mentioned configuration, if the printing unit and the copying unit are controlled based on the mode switched into by the switch unit, and the mode is the printing/copying mode, then the printing unit and the copying unit are controlled to be substantially simultaneously driven in the printing/copying mode. Therefore, the above mentioned first object can be attained. To substantially simultaneously drive the above mentioned printing unit and copying unit includes at least to simultaneously drive the printing unit and the copying unit, to concurrently drive the printing unit and the copying unit, to continuously start driving the printing unit and the copying unit, and to continuously driving the printing unit and the copying unit. When both units (printing unit and copying unit) are continuously started to drive, either of them can be first started to drive. When both units are continuously driven, either of them can be first driven.

The printer device capable of installing a plurality of storage media according to the third aspect of the present invention includes: a first selection portion for selecting a first storage medium from a plurality of installed storage media; a second selection portion for selecting predetermined image information from the image information stored in the selected first storage medium; a copying unit for copying the predetermined image information selected by the second selection portion to a second storage medium different from the first storage medium; a printing unit for printing the predetermined image information selected by the second selection portion; and a continuous drive mode specification portion capable of specifying a continuous drive mode in which a copying operation of copying the predetermined image information to the second storage medium and a printing operation of printing the image information used in the copying operation are continuously performed.

With the above mentioned configuration, when the continuous mode specification portion specifies the continuous drive mode, the operations of copying and printing predetermined image information (image file, etc.) selected by the second selection portion are continuously performed. Therefore, the above mentioned first object can be attained.

### BRIEF DESCRIPTION OF THE DRAWINGS

The present invention will be more apparent from the following detailed description when the accompanying drawings are referenced.

FIG. 1A is an oblique view of the appearance of the printer device according to an embodiment of the present invention;

FIG. 1B shows the operation panel in detail;

FIG. 2 is a block diagram of the system configuration of the printer device according to an embodiment of the present invention;

FIG. 3 is a flowchart showing an example of a controlling process performed when the supply switch of the printer device is turned ON;

FIG. 4 is a flowchart showing an example of the process of selecting a memory card and displaying data when the system is initialized;

FIG. 5 is a flowchart showing an example of the process of selecting a memory card and displaying data in a normal operation;

FIG. 6 is a flowchart showing an example of a printing process;

FIG. 7 is a flowchart showing an example of an inter-card file copying process;

FIG. 8A shows the structure of a directory before a copying process;

FIG. 8B shows the structure of a directory after a copying process; and

FIG. 9 is a flowchart showing an example of a selection mode changing process.

### Description of the Preferred Embodiment

The embodiments of the present invention are described below by referring to the attached drawings. In the embodiments according to the present invention, the information about captured images (captured frame image, frame, etc.) obtained by capturing images by an electronic camera is applied as an example of image information. However, the image information is not limited to this application, but can be, for example, the information about an edited image obtained by performing an image process on a captured image, the information about a generated image newly generated from the beginning by a user, etc.

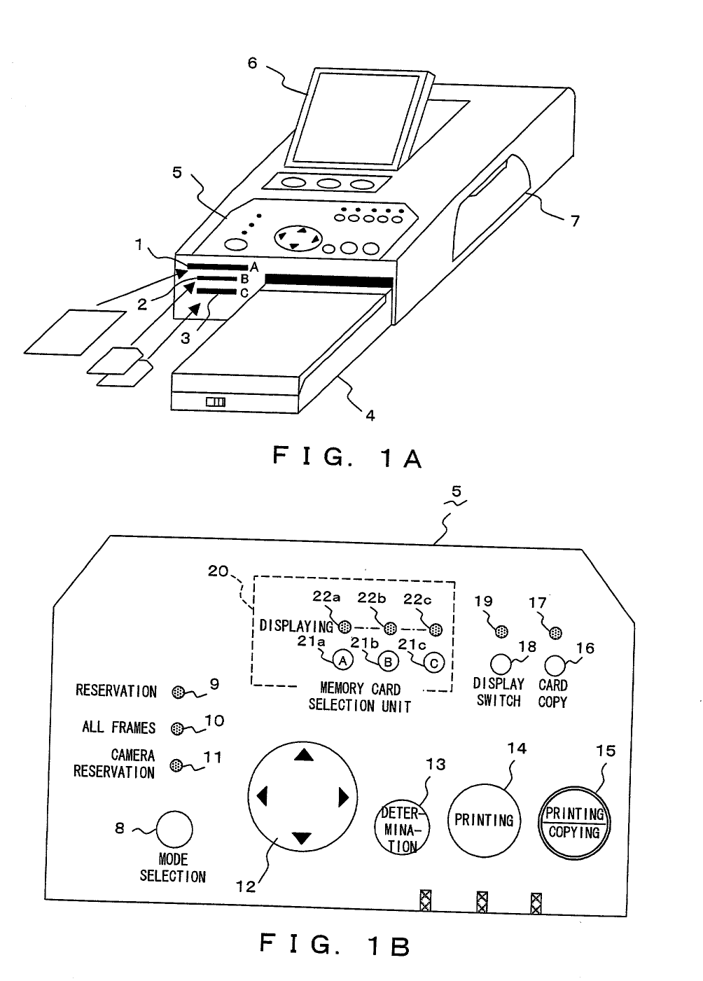

FIG. 1A is an oblique view of the appearance of the printer device according to an embodiment of the present invention. FIG. 1B shows the operation panel in detail. The printer device according to the present embodiment is a thermal transfer printer device for performing a sublimation dye transfer printing process by frame sequential method using an ink ribbon of Y (yellow), M (magenta), and C (cyan).

In FIG. 1A, the printer device is provided with card slots 1, 2, and 3 into which a memory card is inserted, and a paper tray 4 in the front panel of the device. An operation panel 5 and an LCD monitor 6 are provided on the top surface of the device. A flap 7, etc. for attaching/detaching an ink ribbon is provided in the right side of the device.

The card slot 1 is a card slot into which a PC (personal computer) card, Compact Flash (registered trademark of Sun Disk Corporation), etc. are inserted. The card slots 2 and 3 are card slots into which smart media are inserted.

A, B, and C described on the front surface of the device indicate the names of the drives corresponding to the card slots 1, 2, and 3 respectively. That is, the drive A corresponds to the card slot 1, the drive B corresponds to the card slot 2, and the drive C corresponds to the card slot 3.

The paper tray 4 stores plural pieces of paper (recording paper), and receives printed paper on its top.

The LCD monitor 6 displays the image information (information based on an image file, etc.) read from the memory card inserted into the card slots 1, 2, and 3, the information about the mode being selected, various warning messages, etc.

The flap 7 opens and closes for an ink ribbon.

The operation panel 5 receives various instructions from a user, and has a mode selection key 8 for selection of any of the reservation mode, the all frame mode (all frames specification mode), and the camera reservation mode (a camera specification mode); an LED 9 lighted when the reservation mode is selected; an LED 10 lighted when the all frame mode is selected, an LED 11 lighted when the camera reservation mode is selected; a cross key 12 for moving a cursor (pointer) of a frame (captured image frame) and a menu displayed on the LCD monitor 6; a determination key 13 for selection of a frame and a menu pointed to by the cursor displayed on the LCD monitor 6; a printing key 14 for instruction to start the printing process; a printing/copying key 15 for instruction to start the process of substantially simultaneously starting the printing process and the copying process; a card copying key 16 (hereinafter referred to simply as a copying key) for instruction to start the copying process; an LED 17 lighted when the copying process is being performed; a display switch key 18 for instruction to switch the image display format displayed on the LCD monitor 6 into either an index display format or a full image display format; an LED 19 lighted when the full image display format is selected; a memory card selection unit 20, etc. as shown in FIG. 1B.

The memory card selection unit 20 comprises a memory card selection key 21 (21a, 21b, and 21c) and a LED 22 (22a, 22b, and 22c) provided corresponding to the card slots 1, 2, and 3. The A, B, and C described on the memory card selection key 21 correspond to the above mentioned drive names.

The memory card selection key 21 is used to select a memory card inserted into any of the card slots 1, 2, and 3 (drives A, B, and C). When the user presses the memory card selection key 21, a memory card inserted into the corresponding card slot is selected. For example, when the user selects a memory card inserted into the card slot 2, the user is to press the memory card selection key 21b corresponding to the card slot 2.

The LED 22 is lighted corresponding to the card slot into which the selected memory card is inserted. For example, when the selected memory card is inserted into the card slot 3, the LED 22c corresponding to the card slot 3 is lighted.

Described below is the system configuration of the printer device.

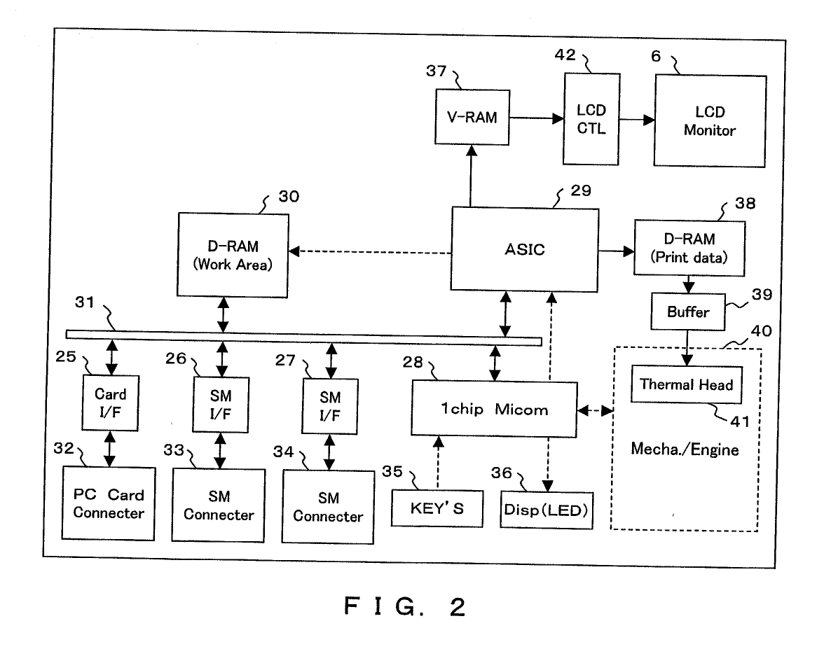

FIG. 2 is a block diagram of the system configuration of the printer device.

In FIG. 2, a card interface (Card I/F) 25, SM (smart media) interfaces (SM/IF) 26 and 27, a 1-chip microcomputer (1-chip micom) 28, an ASIC (application specific integrated Circuit) 29, and a D-RAM 30 are connected to a bus 31, and data is transmitted and received through the bus 31.

The card interface 25 is provided between a PC card connector 32 and the bus 31, functions as an interface for connection of a PC card inserted into the card slot 1 for connection to the PC card connector 32 to the bus 31, and allows data to be transmitted and received between each component connected to the bus 31 and the PC card.

The SM interface 26 is provided between an SM connector 33 and the bus 31, functions as an interface for connection of a smart medium inserted into the card slot 2 for connection to the SM connector 33 to the bus 31, and allows data to be transmitted and received between each component connected to the bus 31 and the smart medium.

The SM interface 27 is provided between an SM connector 34 and the bus 31, functions as an interface for connection of a smart medium inserted into the card slot 3 for connection to the SM connector 34 to the bus 31, and allows data to be transmitted and received between each component connected to the bus 31 and the smart medium.

The 1-chip microcomputer 28 is a central processing unit, uses the D-RAM 30 as a work area according to the control program stored in advance, and controls the operation of the entire printer device. For example, it performs a corresponding process at various instructions from the user received using a KEY′ S35, and also performs the process of turning on or off a corresponding LED of a Disp (LED) 36.

The KEY′ S35 receives various instructions from the user, and notifies the 1-chip microcomputer 28 of the received instruction. For example, various keys, buttons, etc. provided on the operation panel 5 are contained in the KEY′ S35.

The Disp (LED) 36 lights the corresponding LED under the control of the 1-chip microcomputer 28. For example, various types of LED, etc. provided on the above mentioned operation panel 5 are contained in the Disp (LED) 36.

The ASIC 29 performs various image processes such as a data extending process, a resizing process, etc. on image data stored in a memory card after a compressing process in, for example, the JPEG (joint photographic coding experts group) system. To display the image based on the image data after the image process on the LCD monitor 6, it performs a process of outputting the image data obtained after the image process to a V-RAM (video RAM) 37, a process of converting the image data obtained after the image process into frame sequential data (print data) of Y (yellow), M (magenta), and C (cyan), and sequentially outputting the data for printing to a D-RAM 38, etc.

The D-RAM 30 is memory used for temporary storage of image data being processed in various image processes by the ASIC 29, and used as a work area for use in a control process.

The V-RAM 37 is memory temporarily storing image data obtained by performing the data extending process, the resizing process, etc. by the ASIC 29 to display an image based on the image data on the LCD monitor 6.

An LCD controller (LCD CTL) 42 controls the LCD monitor 6 based on the image data stored in the V-RAM 37 to display the image based on the image data on the LCD monitor 6.

The LCD monitor 6 displays the image based on the image data under the control of the LCD controller 42.

The D-RAM 38 is memory sequentially storing print data converted into frame sequential data of Y (yellow), M (magenta), and C (cyan) for printing after performing the data extending process, the resizing process, etc. by the ASIC 29.

A buffer 39 sequentially stores the print data stored in the D-RAM 38 for each piece of line data corresponding to a thermal head 41 of a printing mechanism unit 40. The stored line data is sequentially transmitted to the printing mechanism unit 40.

The printing mechanism unit 40 performs a printing process by sublimating and adsorbing the dyestuff of the ink film (ink ribbon) on paper by driving the thermal head 41 based on the line data sequentially output from the buffer 39. At this time, the paper is moved forward and backward along the longer side of the paper by a feed roller (not shown in the attached drawings), etc. in response to the sequential application of each color ink film of Y (yellow), M (magenta), and C (cyan), thereby realizing an overlapping printing process using three color ink films.

Described below in detail is the control process by the 1-chip microcomputer 28 of the printer device with the above mentioned configuration. This process is performed by the 1-chip microcomputer 28 executing the control program stored therein.

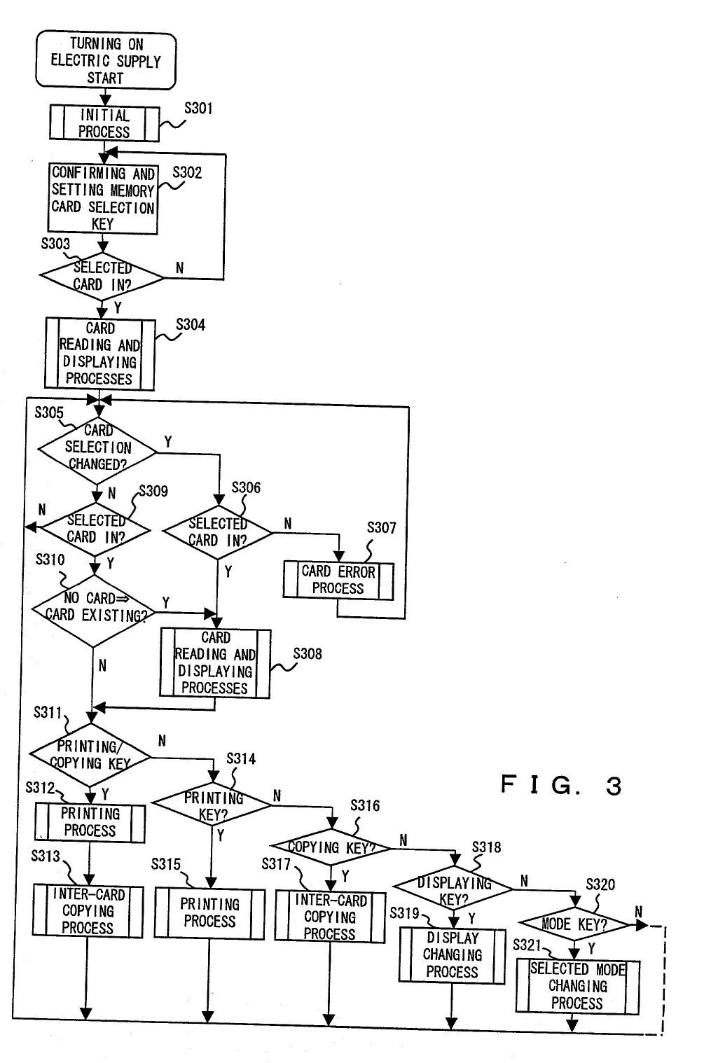

FIG. 3 is a flowchart of an example of a control process performed when the supply switch of the printer device is turned on.

As shown in FIG. 3, when the supply switch not shown in the attached drawings is turned on, the process of initializing the 1-chip microcomputer 28 itself, and each component of the printer device including the printing mechanism unit 40, etc. is first performed (step (hereinafter referred to simply as S) 301).

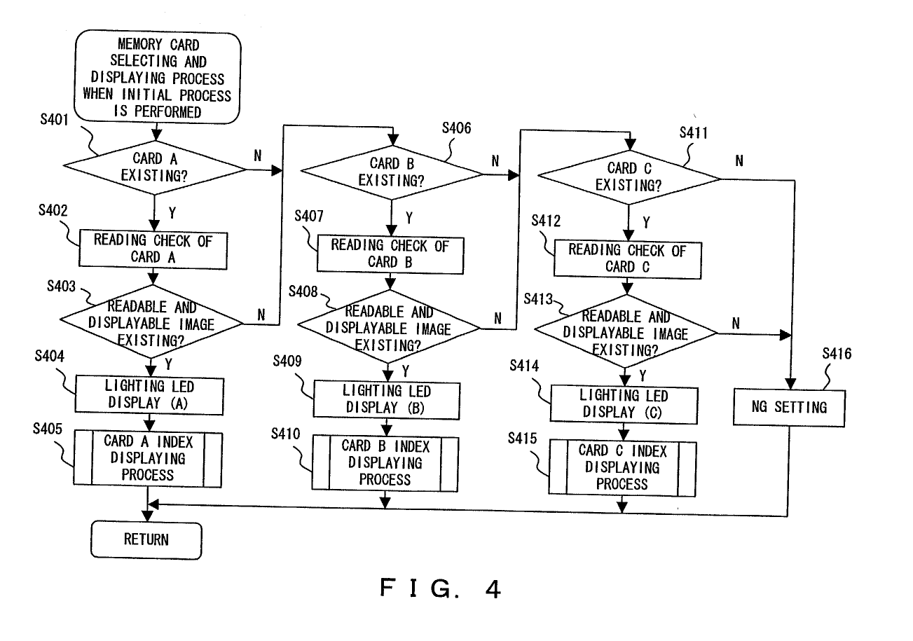

Then, the processes of selecting a memory card and displaying data for the initializing process are performed (S302 through S304). In this process, it is sequentially determined whether or not a memory card containing image data readable and displayable to each card slot has been inserted therein, displays the index after reading the image data readable and displayable from the memory card when such a memory card is inserted, and performs a process of lighting the LED 22 corresponding to the card slot into which the memory card has been inserted. The memory card for which an index has been displayed is set as a memory card selected in the initializing process. The processes in S302 through 304 are described later by referring to FIG. 4.

Then, normal memory card selecting and displaying processes are performed (S305 through S310). In this process, to determine whether or not a selected memory card has been changed, it is determined whether or not the memory card selection key 21 has been pressed (S305). In this determining process, if the memory card selection key 21 has been pressed (Y in S305), then it is further determined whether or not a memory card has been inserted into the card slot corresponding to the memory card selection key 21 (S306). If it has been inserted (Y in S306), then image data readable from the memory card is read and the index is displayed (S308), the memory card is set as a selected memory card, and control is passed to the subsequent process in S311. On the other hand, if no memory card has been inserted (N in S306), then an error process is performed by, for example, displaying a warning that no memory card has been inserted on the LCD monitor 6, etc. (S307), and control is passed to the process in S305.

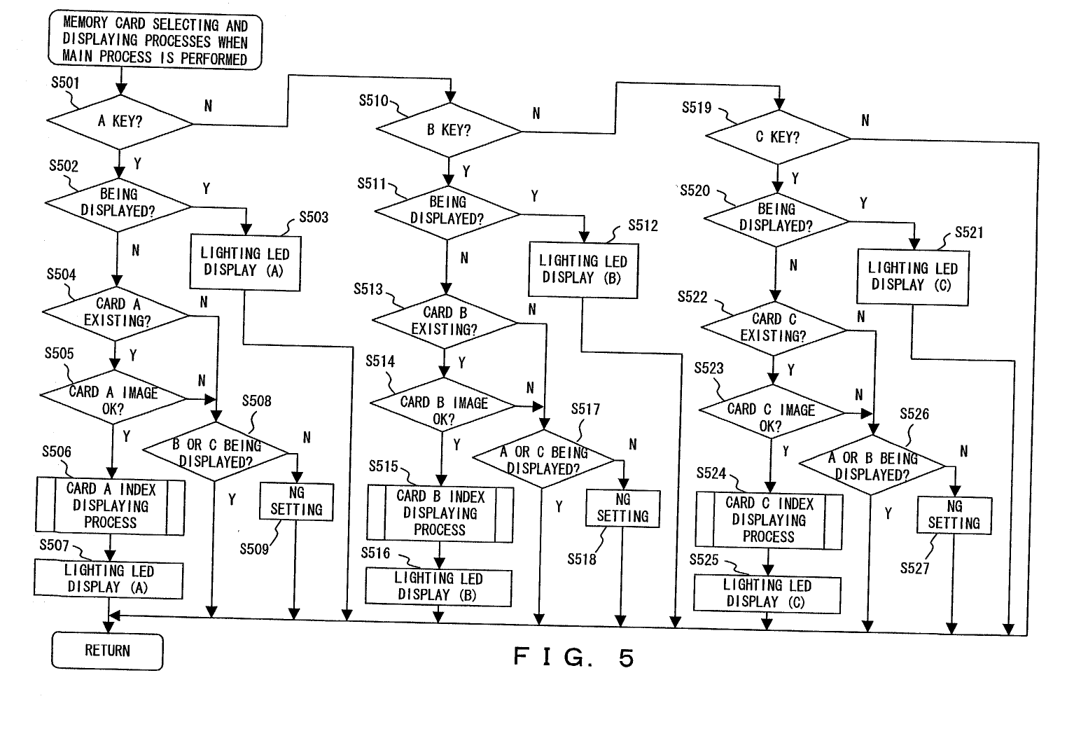

On the other hand, if it is determined that the memory card selection key 21 has not been pressed in the determining process in S305 (N in S305), then it is determined whether or not the selected memory card bas been inserted (S309). If the selected memory card has not been inserted (N in S309), then control is returned to S305. If the selected memory card has been inserted (Y in S309), then it is further determined whether or not the memory card has been newly inserted, that is, whether or not the memory card has been preceded by no card (S310). If it is determined in this determining process that the memory card has been newly inserted (Y in S310), image data readable and displayable from the memory card is read, and an index is displayed (S308). If not (N in S310), then control is passed to the subsequent process in S311. The processes in S305 through S310 are described later by referring to FIG. 5.

The selected memory card is set as described above, and is then set in the memory card of a printing source, the memory card of a copying source.

Then, various instructions from a user can be accepted through the KEY′ S35, and control is passed to the corresponding processes (S311 through S321).

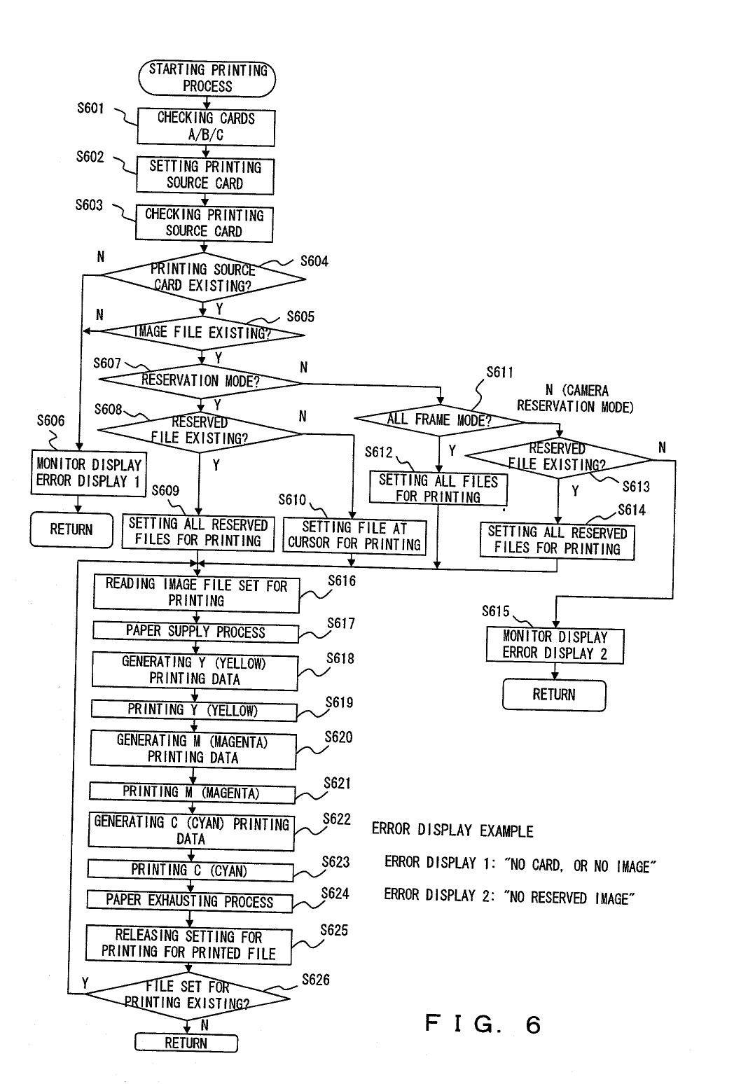

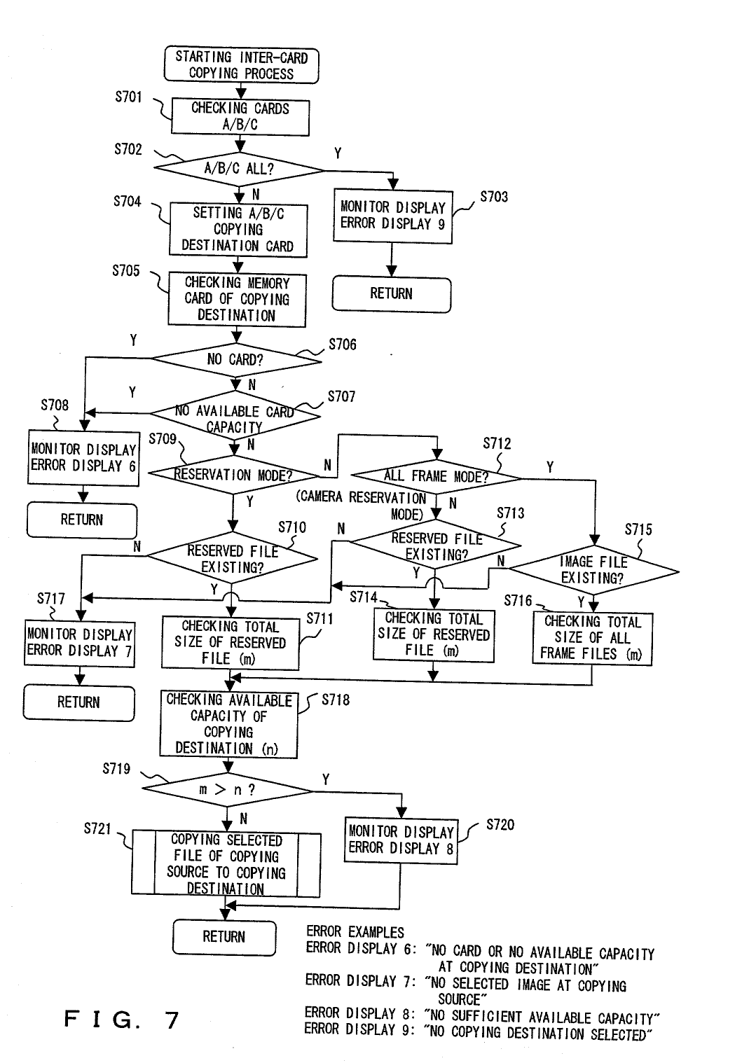

In these processes, if the user presses the printing/copying key 15 of the operation panel 5 and issues an instruction to print/copy data (to enter a printing/copying mode or a continuous driving mode)(Y in S311), then the printing process described later by referring to FIG. 6 (S312) and the copying process described later by referring to FIG. 7 (inter-card file copying process) (S313) are substantially simultaneously performed based on the mode being selected (any of the reservation mode, the all frame mode, and the camera reservation mode). In this example, the processes are performed substantially simultaneously by performing the copying process (S313) after performing the printing process (S312). Thus, according to the present embodiment, the processes are performed substantially simultaneously by continuously performing the copying process and the printing process. However, both processes can be concurrently performed, simultaneously started, or continuously started. If the processes are continuously performed, either process can be first performed. If the processes are continuously started, then either process can be first started.

By performing the above mentioned processes, the printing process and the copying process independently performed at separate instructions from the user can be performed by one instruction. Therefore, when the same frame is to be printed and copies, and the printing process and the copying process have to be quickly performed, the convenience of the user can be greatly improved. For example, the above mentioned method is appropriate when an image of an impressive scene in one of the frames index-displayed is to be printed for appreciation, and simultaneously when the image file of the frame is to be copied to another memory card for management (storage), etc.

However, when the copying process cannot be performed because there is no sufficient storage capacity (remaining storage capacity) in the memory card of the copying destination in the copying process (S313), only the printing process (S312) is performed without performing the copying process (S313). At this time, the warning message, etc. that only the printing process is performed without performing the copying process is displayed on the display screen of the LCD monitor 6 so that the warning can be given to the user.

Otherwise, when the printing key 14 is pressed and an instruction to print data (instruction to enter the printing mode) is issued (Y in S314), the printing process (S315) described later is performed by referring to FIG. 6 in the mode being selected (any of the reservation mode, the all frame mode, and the camera reservation mode). When the printing process (S315) is performed without changing the mode or selecting the frame after performing the copying process (S317), the printing process is performed based on the frame copied in the copying process (S317). Therefore, when the user selects a frame for a copying process, and then prints the same frame, it is not necessary to select the frame again for a printing process, thereby improving the convenience of the user.

When the copying key 16 is pressed and an instruction to copy data (instruction to enter the copying mode) is issued (Y in S316), the copying process (S317) described later is performed by referring to FIG. 7 in the mode being selected (any of the reservation mode, the all frame mode, and the camera reservation mode). When the copying process (S317) is performed without changing the mode or selecting the frame after performing the printing process (S315), the copying process is performed based on the frame printed in the printing process (S315). Therefore, when the user selects a frame for a printing process, and then copies the same frame, it is not necessary to select the frame again for a copying process, thereby improving the convenience of the user.

When the display switch key 18 is pressed and an instruction to change the display is issued (Y in S318), the display changing process (S319) is performed. In this display changing process (S319), the image display format of the LCD monitor 6 is switched into an index display format or a full image display format. That is, if the current format is the full image display format, it is switched into the index display format. If the current format is the index display format, then the frame being pointed to by the cursor is switched into the full image display format. When the full image display format is selected, the LED 19 is lighted.

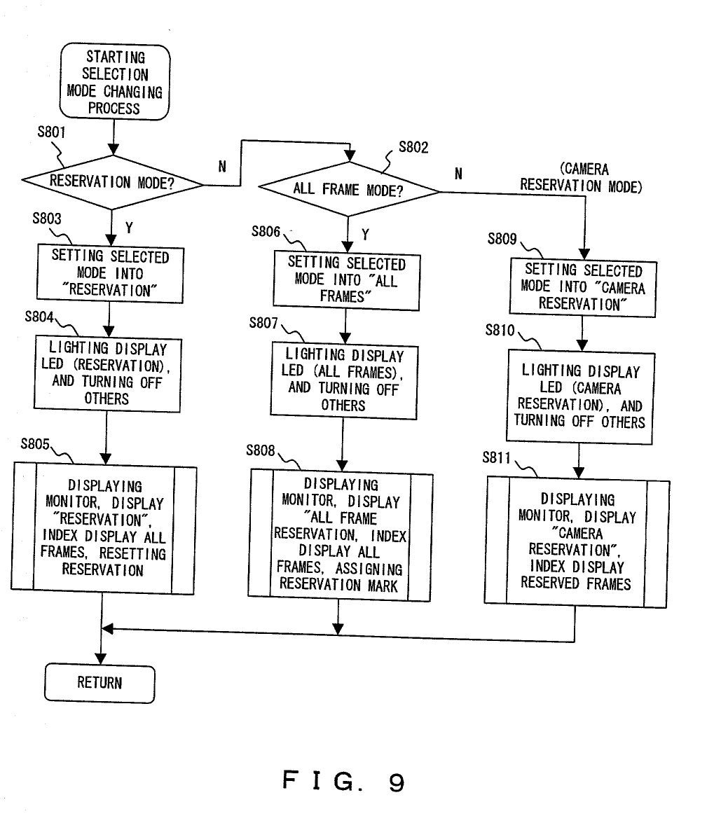

When the mode selection key 8 is pressed and the instruction to select a mode is issued (Y in S320), the selection mode changing process (S321) described later by referring to FIG. 9 is performed. In this selection mode changing process, the LCD monitor 6 can display the selection (specification) of a mode (the reservation mode, the camera reservation mode, the all frame mode), etc.

Although not shown in the attached drawings, various instructions can be received from a user and processes corresponding to the instructions can be performed.

Thus, if the process performed based on the above mentioned user instruction is completed, or no instructions are received from a user, then control is returned to the process in S305, and the memory card selecting process and the displaying process in the above mentioned normal operation (S305 through S310) and the processes (S311 through S321) of performing corresponding processes upon receipt of various instructions from users are repeated.

In the flow of the processes shown in FIG. 3, an instruction from a user is received in the order of the printing/copying key 15, the printing key 14, the card copying key 16, the display switch key 18, and the mode selection key 8. However, the order is not limited to this.

The memory card selecting process and the displaying process performed when the initializing process is performed and described by referring to the processes in S302 through S304 are described below in detail.

FIG. 4 is a flowchart showing an example of the memory card selecting process and the displaying process performed when the initializing process is performed. As described above, each card slot is assigned in advance a priority number. In this example, the card slot 1 (drive A), the card slot 2 (drive B), and the card slot 3 (drive C) are arranged in order from the highest priority. The process of determining whether or not a memory card has been inserted in the process flow is performed in the priority order. It is obvious that the priority order is not limited to the order described above.

In FIG. 4, in the above mentioned priority order, it is first determined whether or not a memory card has been inserted into the card slot 1 (S401). If the memory card has been inserted (Y in S401), then the process of read checking the memory card is performed (S402), and it is determined whether or not there is readable and displayable image data (S403). If there is readable and displayable image data (Y in S403), then the LED 22a corresponding to the card slot 1 into which the memory card is inserted is lighted (S404), the index is displayed (S405) for the readable and displayable image data in the memory card, and the memory card is set as a selected memory card, thereby returning control from the flow.

If no memory card has been inserted into the card slot 1 (N in S401), or there is no readable and displayable image data in the memory card inserted into the card slot 1 (N in S403), then it is determined based on the above mentioned priority order whether or not a memory card has been inserted into the card slot 2 (S406). If a memory card has been inserted into the card slot 2 (Y in S406), then the read checking process is performed on the memory card (S407), and it is determined whether or not there is readable and displayable image data (S408). If there is readable and displayable image data (Y in S408), then the LED 22b corresponding to the card slot 2 into which the memory card has been inserted is lighted (S409), the index of the readable and displayable image data of the memory card is displayed (S410), the memory card is set as a selected memory card, and control is returned from the flow.

If no memory card has been inserted into the card slot 2 (N in S406), or there is no readable and displayable image data in the memory card inserted into the card slot 2 (N in S408), then it is determined based on the above mentioned priority order whether or not a memory card has been inserted into the card slot 3 (S411). If a memory card has been inserted into the card slot 3 (Y in S411), then the read checking process is performed on the memory card (S412), and it is determined whether or not there is readable and displayable image data (S413). If there is readable and displayable image data (Y in S413), then the LED 22c corresponding to the card slot 3 into which the memory card has been inserted is lighted (S414), the index of the readable and displayable image data of the memory card is displayed (S415), the memory card is set as a selected memory card, and control is returned from the flow.

If no memory card has been inserted into the card slot 3 (N in S411), or there is no readable and displayable image data in the memory card inserted into the card slot 3 (N in S413), then an NG setting process (S416) is performed by displaying a warning that a memory card containing readable and displayable image data has not been inserted into any card slot, etc., and control is returned from the flow. In this case, for example, the memory card inserted into the card slot 1 can be set as a selected memory card.

In the flow shown in FIG. 4, it is sequentially determined whether or not a memory card containing readable and displayable image data has been inserted into a card slot based on the priority order. When it is determined that such a memory card has been inserted, the index from the memory card is displayed. It is also possible, for example, to determined in advance whether or not a memory card containing readable and displayable image data has been inserted in the card slots, and display the index from the memory card of the highest order based on the priority order assigned to each card slot if a plurality of the above mentioned memory cards have been inserted.

Described below are the memory card selecting process and the displaying process in the normal operation described above by referring to the processes in S305 through S310 shown in FIG. 3.

FIG. 5 is a flowchart of an example of the memory card selecting process and the displaying process in the normal operation. In the flow shown in FIG. 5, it is first determined whether or not the memory card selection key 21a has been pressed (S501). If the memory card selection key 21a has been pressed (Y in S501), then it is further determined whether or not the memory card inserted in the card slot 1 corresponding to the memory card selection key 21a is a memory card being read and displayed (S502). If it is being read and displayed (Y in S502), then the LED 22a is turned off (S503), and the setting of the memory card as a selected memory card is released, thereby returning control from the flow.

On the other hand, if the memory card inserted into the card slot 1 is not a memory card being read and displayed (N in S502), it is further determined whether or not a memory card has been inserted into the card slot 1 (S504). If any memory card has been inserted (Y in S504), then it is further determined whether or not the memory card contains readable and displayable image data (S505) If it contains readable and displayable image data (Y in S505), then the readable and displayable image data is read, and the index is displayed (S506), the LED 22a is lighted (S507), and the memory card is set as a selected memory card, thereby returning control from the flow.

On the other hand, if no memory card has been inserted into the card slot 1 (N in S504), or an inserted memory card contains no readable and displayable image data (N in S505), then it is determined whether or not data is being read and displayed from a memory card inserted into the card slot 2 or 3 (S508). If data is being read and displayed from such a memory card (Y in S508), then control is returned from the flow. If not (N in S508), then the NG setting process is performed by displaying a warning that, for example, a memory card containing readable and displayable image data is not inserted into the card slot 1, etc. (S509), thereby returning control from the flow.

On the other hand, if the memory card selection key 21a has not been pressed in the determining process in S501 (N in S501), then it is further determined whether or not the memory card selection key 21b has been pressed (S510). If the memory card selection key 21b has been pressed (Y in S510), then it is determined whether or not the memory card inserted into the card slot 2 corresponding to the memory card selection key 21b is a memory card being read and displayed (S511). If it is being read and displayed, (Y in S511), then the corresponding LED 22b is turned off (S512), and the setting of the memory card as a selected memory card is released, thereby returning control from the flow.

On the other hand, if the memory card inserted into the card slot 2 is not a memory card being read and displayed (N in S511), it is further determined whether or not a memory card has been inserted into the card slot 2 (S513). If any memory card has been inserted (Y in S513), then it is further determined whether or not the memory card contains readable and displayable image data (S514) If it contains readable and displayable image data (Y in S514), then the readable and displayable image data is read, and the index is displayed (S515), the LED 22b is lighted (S516), and the memory card is set as a selected memory card, thereby returning control from the flow.

On the other hand, if no memory card has been inserted into the card slot 2 (N in S513), or an inserted memory card contains no readable and displayable image data (N in S514), then it is determined whether or not data is being read and displayed from a memory card inserted into the card slot 1 or 3 (S517). If data is being read and displayed from such a memory card (Y in S517), then control is returned from the flow. If not (N in S517), then the NG setting process is performed by displaying a warning that, for example, a memory card containing readable and displayable image data is not inserted into the card slot 2, etc. (S518), thereby returning control from the flow.

On the other hand, if the memory card selection key 21b has not been pressed in the determining process in S510 (N in S510), then it is further determined whether or not the memory card selection key 21c has been pressed (S519). If the memory card selection key 21c has been pressed (Y in S519), then it is determined whether or not the memory card inserted into the card slot 3 corresponding to the memory card selection key 21c is a memory card being read and displayed (S520). If it is being read and displayed, (Y in S520), then the corresponding LED 22c is turned off (S521), and the setting of the memory card as a selected memory card is released, thereby returning control from the flow.

On the other hand, if the memory card inserted into the card slot 3 is not a memory card being read and displayed (N in S520), it is further determined whether or not a memory card has been inserted into the card slot 3 (S522). If any memory card has been inserted (Y in S522), then it is further determined whether or not the memory card contains readable and displayable image data (S523) If it contains readable and displayable image data (Y in S523), then the readable and displayable image data is read, and the index is displayed (S524), the LED 22c is lighted (S525), and the memory card is set as a selected memory card, thereby returning control from the flow.

On the other hand, if no memory card has been inserted into the card slot 3 (N in S522), or an inserted memory card contains no readable and displayable image data (N in S523), then it is determined whether or not data is being read and displayed from a memory card inserted into the card slot 1 or 2 (S526). If data is being read and displayed from such a memory card (Y in S526), then control is returned from the flow. If not (N in S526), then the NG setting process is performed by displaying a warning that, for example, a memory card containing readable and displayable image data is not inserted into the card slot 3, etc. (S527), thereby returning control from the flow.

If no memory card selection key 21 has been pressed (N in S519), control is returned, control is returned from the flow.

Described below is the printing process described above by referring to the process in S312 or S315 shown in FIG. 3.

FIG. 6 is a flowchart showing an example of the printing process. In the flowchart shown in FIG. 6, a selected memory card in the memory cards inserted into the card slots 1, 2, and 3 (drives A, B, and C) (S601), and the selected memory card is set as a memory card of the printing source (S602).

Then, a checking process is performed on a memory card set in the printing source (S603), and determined whether or not the memory card of the printing source has been inserted (S604), and whether or not there is image data in the memory card (S605). If the memory card of the printing source has not been inserted (N in S604) or the memory card contains no image data (N in S605), then an error display 1 ‘No cards or images’ is displayed on the display screen of the LCD monitor 6 (S606), thereby returning control from the flow.

On the other hand, if the memory card of the printing source has been inserted (Y in S604), and the memory card contains image data (Y in S605), then control is passed to the process of setting the image file for printing in the mode being selected (any of the reservation mode, the camera reservation mode, and the all frame mode).

If the mode being selected is a reservation mode (Y in S607), then it is determined whether or not the memory card of the printing source contains a reserved file (an image file (image information) of the frame reserved by the cross key 12, the determination key 13, etc.) (S608). If there is a reserved file (Y in S608), the reserved file is set for printing (S609). If there are no reserved files (N in S608), the image file of the frame pointed to by the cursor displayed on the LCD monitor 6 is set for printing (S610) If the mode being selected is the all frame mode (N in S607, and Y in S611), all image files stored in the memory card of the printing source are set for printing (S612).

Otherwise, if the mode being selected is the camera reservation mode (N in S607, and N in S611), then it is determined whether or not the memory card of the printing source contains a reserved file (image file reserved by an electronic camera) (S613). If it contains a reserved file (Y in S613), then the reserved file is set for printing (S614). If it does not contain a reserved file (N in S613), then the display screen of the LCD monitor 6 displays the error display 2 ‘No reserved image.’ (S615), thereby returning control from the flow.

Thus, when an image file is completely set for printing, the process of printing data actually on paper is started.

First, the image data of the image file set for printing is read, and the image data is uncompressed(S616).

Then, paper is supplied from the paper tray 4, and the paper is set on the printing starting position (S617).

Then, the plane data (printing data) of Y (yellow) is generated from the image data which has been uncompressed (S618), and the plane data is output to the thermal head 41 for each piece of 1-line data, and all plane data of Y (yellow) is printed on paper while controlling the paper and the ink ribbon to move them to the corresponding printing position (S619).

Then, the plane data (printing data) of M (magenta) is generated from the image data which has been uncompressed (S620), and the plane data is output to the thermal head 41 for each piece of 1-line data, and all plane data of M (magenta) is printed on paper while controlling the paper and the ink ribbon to move them to the corresponding printing position (S621).

Then, the plane data (printing data) of C (cyan) is generated from the image data which has been uncompressed (S622), and the plane data is output to the thermal head 41 for each piece of 1-line data, and all plane data of C (cyan) is printed on paper while controlling the paper and the ink ribbon to move them to the corresponding printing position (S623).

When the color printing process is completed by the frame sequential method, the printed paper is fed onto the top surface of the paper tray 4 (S624), and the setting of the image file, which has been printed, for printing is released (S625).

Then, it is determined whether or not there is still an image file set for printing (S626). If yes (Y in S626), control is returned to the process in S616, and the processes in S616 through S626 are repeated for the image files remaining for printing.

If all image files set for printing have been completely printed (N in S626), control is returned from the flow.

Described below is the copying process described by referring to the process in S313 or S317 in FIG. 3.

FIG. 7 is a flowchart of an example of the copying process. In the flow shown in FIG. 7, a selected memory card is first checked (S701), and it is determined whether or not all three cards inserted into the card slots 1, 2, and 3 (drives A, B, and C) have been set as selected memory cards (S702). If all three memory cards has been set as selected memory cards in this determining process (Y in S702), then a memory card of the copying destination cannot be set. Therefore, the error display 9 ‘Copying destination cannot be selected.’ is displayed on the display screen of the LCD monitor 6 (S703), thereby returning control from the flow.

On the other hand, if one or two of the memory cards inserted into any of the card slots 1, 2, and 3 have been set as selected memory cards (N in S702), then one of the remaining memory cards not set as selected memory cards is set as a memory card of the copying destination (S704). The memory card of the copying destination can be selected by, for example, a user through the memory card selection key 21, etc., or can be automatically set based on the above mentioned priority order assigned to each card slot.

Then, the process of checking a memory card set in the copying destination, for example, the process of detecting an available storage capacity (remaining storage capacity), etc. is performed (S705). Then, it is determined whether or not a memory card of the copying destination is inserted (S706), and whether of not there is a sufficient available storage capacity (S707). If a memory card of the copying destination is not inserted (Y in S706) or there is no sufficient available storage capacity in the memory card (Y in S707), then the error display 6 ‘No card in the copying destination, or no available capacity.’ is displayed on the display screen of the LCD monitor 6 (S708), thereby returning control from the flow. If there is no sufficient available storage capacity in the memory card of the copying destination, the warning can be issued to the user.

If a memory card of the copying destination is inserted (Y in S706) and the memory card has a sufficient available storage capacity (Y in S707), then control is passed to the process of obtaining a total storage capacity (total size) m of the image file to be copied based on the mode being selected (any of the reservation mode, the camera reservation mode, the all frame mode).

When the mode being selected is the reservation mode (Y in S709), it is determined whether or not the memory card of the copying source (selected) contains a reservation file (an image file (image information) of the frame reserved by the cross key 12, the determination key 13, etc.) (S710). If it contains a reserved file, then the total storage capacity m of the reserved file is obtained (S711).

Otherwise, if the selected mode is the camera reservation mode (N in S709, and N in S712), then it is further determined whether or not the memory card of the copying source (selected) contains a reserved file (an image file reserved by an electronic camera) (S713). If it contains a reserved file (Y in S713), then the total storage capacity m of the reserved file is obtained (S714).

If the selected mode is the all frame mode (N in S709, and Y in S712), then it is further determined whether or not the memory card of the copying source (selected) contains an image file (S715). If it contains an image file (Y in S715), then the total storage capacity m of the image file (all frame file) is obtained (S716).

On the other hand, if there is no reserved file in the reservation mode (N in S710), if there is no reserved file in the camera reservation mode (N in S713), or if there is no image file in the all frame mode (N in S715), then the error display 7 ‘There is no image selected in the copying source.’ is displayed on the display screen of the LCD monitor 6 (S717), thereby returning control from the flow.

When the total storage capacity m of the image file to be copied is obtained, the available storage capacity (remaining storage capacity) n of the memory card of the copying destination is detected (S718), and it is determined whether or not the total storage capacity m of the image file to be copied is larger than the available storage capacity n (m>n) (S719). If the total storage capacity m of the image file to be copied is larger than the available storage capacity n (m>n) (Y in S719), then the error display 8 ‘There is no sufficient available capacity in the copying destination.’ is displayed on the display screen of the LCD monitor 6 (S720), thereby returning control from the flow. At this time, a message that no copying process is performed is displayed together with the error display 8, and the user is notified that no copy is made.

If the total storage capacity m of the image file to be copied is smaller than the available storage capacity in the copying destination (m<n) (N in S719), then the image file to be copied is copied to the memory card in the copying destination (S721), thereby returning control from the flow.

However, if the memory card in the copying destination has a directory having the same name as the memory card in the copying source in the process in S721, then a directory having a different name is generated in memory card of the copying destination, and the image file is to be copied to the generated directory.

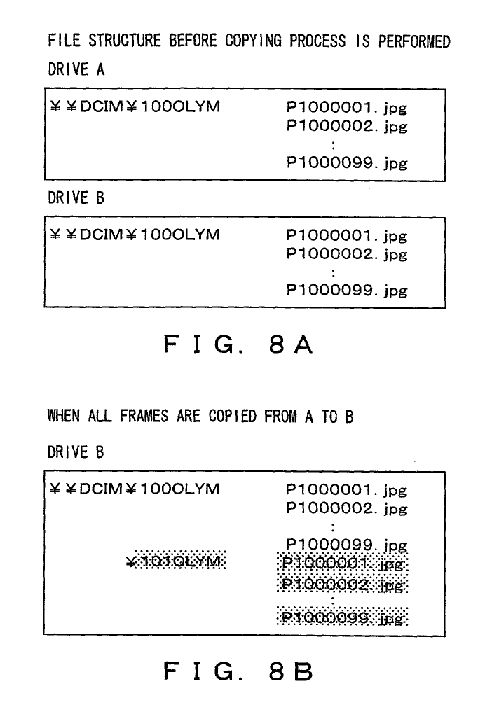

FIGS. 8A and 8B show an example of the above mentioned process in S721.

FIG. 8A shows the directory structure (upper portion in FIG. 8A) of the memory card of the copying source (drive A) and the directory structure (lower portion in FIG. 8A) of the memory card of the copying destination (drive B) before performing the copying process (process in S721). A directory refers to a holder. As shown in FIG. 8A, the memory card of the drive A contains image files ‘P1000001.jpg’ through ‘P1000099.jpg’ in the directory ‘¥¥DCIM¥100OLYM’. The memory card of the drive B contains image files ‘P1000001.jpg’ through ‘P1000099.jpg’ in the directory ‘¥¥DCIM¥100OLYM’.

FIG. 8B shows the directory structure of the memory card of the drive B after copying the image files ‘P1000001.jpg’ through ‘P10000099.jp’ belonging to all frames, that is, ‘¥¥DCIM¥100OLYM’ of the drive A to the drive B in FIG. 8A. Since the memory card in the drive B contains a directory having the same name as the directory (‘¥¥DCIM¥100OLYM’) to which an image file to be copied belongs, a directory having a different name (‘¥¥DCIM¥101OLYM) is generated, and the image file is copied to this directory.

Thus, if the memory card of the copying destination has no directory having the same name as the directory to which an image file to be copied belongs, the entire directory is copied (not shown in the attached drawings). However, if there is a directory having the same name as the directory to which the image file to be copied belongs, then a directory having a different name is generated, and the image file is copied to the directory, thereby preventing an overwrite to the image file.

In the process in S721, if, for example, a memory card of the copying destination contains a directory having the same name as the directory to which an image file to be copied belongs, but if the name of the image file belonging to the directory is different from the name of the image file to be copied, then the image file can be copied to the directory having the same name in the copying destination. Otherwise, regardless of the existence of a directory having the same name in the copying destination, a directory having a different name is generated in the memory card of the copying destination so that the image file can be copied to the generated directory.

Then, the selection mode changing process described above by referring to the process in S321 FIG. 3 is described below in detail.

FIG. 9 is a flowchart showing an example of the selection mode changing process.

In the flowchart shown in FIG. 9, it is determined for which mode the mode selection key 8 has been pressed, the reservation mode, the all frame mode, or the camera reservation mode (S801 and S802). The mode is repeatedly changed in the order of the reservation mode, the all frame mode, and the camera reservation mode each time the mode selection key 8 is pressed.

If the entered mode is the reservation mode (Y in S801), the current mode is set into the reservation mode (S803), the LED 9 is lighted, and the LEDs 10 and 11 are turned off (S804). Then, to notify the user of the reservation mode as the current mode, ‘reservation’ is displayed on the display screen of the LCD monitor 6, and the image (frame) based on the image file read from the memory card inserted into the card slot selected by the memory card selection key 21 is index-displayed (S805). If a reservation mark is applied to the frame displayed at this time, then it is reset. As described above, if the reservation mode is selected, the user can reserve a frame to be printed or copied from among the frames displayed on the LCD monitor 6 by operating the cross key 12 and the determination key 13. Furthermore, by operating the printing key 14, the card copying key 16, and the printing/copying key 15, the reserved frame can be printed and copied. When the user reserves a frame, a reservation mark is assigned to the reserved frame.

Otherwise, when the entered mode is the all frame mode (N in S801, and Y in S802), the current mode is set into the all frame mode (S806), the LED 10 is lighted, and the LEDs 9 and 11 are turned off (S807). Then, to notify the user that the current mode is the all frame mode, ‘all frame reserved’ is displayed on the display screen of the LCD monitor 6, the image (frame) based on the image file read from the memory card inserted into the card slot selected by the memory card selection key 21 is index-displayed, all frames are assigned reservation marks and displayed, and all frames are reserved (S808). Thus, if the all frame mode has been selected, the user operates the printing key 14, the card copying key 16, and the printing/copying key 15, thereby possibly printing and copying all frames.

If the entered mode is the camera reservation mode (N in S801, and N in S802), then the current mode is set into the camera reservation mode (S809), the LED 11 is lighted, and the LEDs 9 and 10 are turned off (S810). Then, to notify the user that the current mode is the camera reservation mode, ‘camera reservation’ is displayed on the display screen of the LCD monitor 6, the image (frame) based on the image file read from the memory card inserted into the card slot selected by the memory card selection key 21 is index-displayed, a reservation mark is assigned to the frame of the image file reserved by an electronic camera, and the frame is displayed (S811). Thus, if the camera reservation mode is selected, the user can print and copy the image file reserved by the electronic camera by operating the printing key 14, the card copying key 16, and the printing/copying key 15.

If the selection mode changing process has been completed, control is returned from the flow.

The printer device according to the present embodiment is operated by the sublimation dye transfer printing method. However, the present invention is not limited to this application, but can be operated by an inkjet printing system and other appropriate systems.

Furthermore, according to the present embodiment, an image file reserved by an electronic camera is to be processed in the camera reservation mode, but can be an image file reserved by a PC and other appropriate external appliances.

The printer device according to the present embodiment is configured by a built-in display device (LCD monitor 6), but the display device can be configured as an external unit.

As described above in detail, according to the present invention, a printer device capable of performing substantially simultaneous copying and printing operations at one user instruction can be provided. In addition, the printer device can continuously perform the copying operation and the printing operation one after the other without re-specifying the image information by the user.

What is claimed is:

1. A printer device capable of copying and printing image information, comprising:
a plurality of installation units installing a storage media;
a first selection unit selecting a first storage medium from among the plurality of storage media installed on said installation units;
a second selection unit selecting arbitrary image information stored in the first storage medium selected by said first selection unit;
a third selection unit selecting one of a copying mode in which the image information is copied to a second storage medium different from the first storage medium and a printing mode in which the image information is printed; and
a mode processing unit processing the arbitrary image information selected by said second selection unit in a first mode selected by said third selection unit, and performing a process in a second mode according to the same image information as in the first mode if the second mode different from the first mode is selected after the process in the first mode is completed.

2. The device according to claim 1, wherein
said first mode is the printing mode, and said second mode is the copying mode.

3. The device according to claim 1, wherein
when, in the second storage medium which is a copying destination, there is a directory having the same name as the first storage medium which is a copying source, the copying mode starts a copying process after automatically generating a directory having a different name in the second storage medium which is a copying destination.

4. The device according to claim 2, wherein
when, in the second storage medium which is a copying destination, there is a directory having the same name as the first storage medium which is a copying source, the copying mode starts a copying process after automatically generating a directory having a different name in the second storage medium which is a copying destination.

5. A printer device capable of copying and printing image information, comprising:
a plurality of installation means for installing a storage media;
first selection means for selecting a first storage medium from among the plurality of storage media installed on said installation means;
second selection means for selecting arbitrary image information stored in the first storage medium selected by said first selection means;
third selection means for selecting one of a copying mode in which the image information is copied to a second storage medium different from the first storage medium and a printing mode in which the image information is printed; and
mode processing means for processing the arbitrary image information selected by said second selection means in a first mode selected by said third selection means, and performing a process in a second mode according to the same image information as in the first mode if the second mode different from the first mode is selected after the process in the first mode is completed.

6. A printer device capable of installing a plurality of storage media, comprising:
a first selection unit selecting a predetermined storage medium from a plurality of installed storage media;
a second selection unit selecting predetermined image information from image information stored in a first storage medium selected by said first selection unit;
a printing unit printing predetermined image information selected by said second selection unit;
a copying unit copying the predetermined image information selected by said second selection unit to a second storage medium selected by said first selection unit;
a switch unit switching a mode into a printing mode in which said printing unit is driven, a copying mode in which said copying unit is driven, or a printing/copying mode in which said printing unit and said copying unit are substantially simultaneously driven; and
a control unit controlling said copying unit and said printing unit in the switched-to mode into which said switch unit has switched.

7. The device according to claim 6, wherein
said second selection unit selects the predetermined image information from among at least:
an all frame specification mode in which all image information stored in the selected first storage medium is specified;
a reservation mode in which specific image information is arbitrarily specified from image information stored in the selected first storage medium; and
a camera specification mode in which information preset for the image information stored in the selected first storage medium is specified.

8. The device according to claim 7, further comprising
a display device capable of performing a displaying process for specification of any of the modes and displaying image information, wherein
said control unit allows the mode status and image information selected by said second selection unit to be displayed while an operator is watching the display device.

9. The device according to claim 6, wherein
said switch unit comprises a printing mode specification portion for specification of the printing mode, a copying mode specification portion for specification of the copying mode, and a printing/copying mode specification portion for specification of the printing/copying mode.

10. The device according to claim 9, wherein
when said printing/copying mode specification portion specifies the printing/copying mode, said control unit drives said printing unit, performs the printing process, drives the copying unit, and performs a copying process among storage media.

11. The device according to claim 10, wherein
there is one second storage medium which is a copying destination.

12. The device according to claim 6, wherein
when said plurality of storage media are installed on a plurality of storage medium installation units assigned priority orders, and before said first selection unit selects said first storage medium, said control unit determines whether or not readable and displayable image exists, and, when readable and displayable images are contained in the plurality of storage media, a storage medium having a highest priority order is index-displayed based on the priority order.

13. The device according to claim 6, wherein
when said copying mode is performed, said control unit detects a remaining storage capacity of the second storage medium, and issues a warning when said control unit determines that the storage capacity is insufficient.

14. A printer device capable of installing a plurality of storage media, comprising:
first selection means for selecting a predetermined storage medium from a plurality of installed storage media;
second selection means for selecting predetermined image information from image information stored in a first storage medium selected by said first selection means;
printing means for printing predetermined image information selected by said second selection means;
copying means for copying the predetermined image information selected by said second selection means to a second storage medium selected by said first selection means;
switch means for switching a mode into a printing mode in which said printing means is driven, a copying mode in which said copying means is driven, or a printing/copying mode in which said printing means and said copying means are substantially simultaneously driven; and
control means for controlling said copying means and said printing means in the switched-to mode into which said switch unit has switched.

15. A printer device capable of installing a plurality of storage media, comprising:
a first selection portion for selecting a first storage medium from a plurality of installed storage media;
a second selection portion for selecting predetermined image information from image information stored in the selected first storage medium;
a copying unit copying the predetermined image information selected by said second selection portion to a second storage medium different from the first storage medium;
a printing unit printing predetermined image information selected by said second selection portion; and
a continuous drive mode specification portion capable of specifying a continuous drive mode in which an operation of copying the predetermined image information to the second storage medium and an operation of printing the same image information can be continuously performed.

16. The device according to claim 15, wherein
said second selection portion selects the predetermined image information from among at least:
an all frame specification mode in which all image information stored in the selected first storage medium is specified;
a reservation mode in which specific image information is arbitrarily specified from image information stored in the selected first storage medium; and
a camera specification mode in which information preset for the image information stored in the selected first storage medium is specified.

17. The device according to claim 15, further comprising
a detection unit detecting a remaining storage capacity of a storage medium of a copying destination when the continuous drive mode is specified by said continuous drive mode specification portion,

18. The device according to claim 17, wherein
when said detection unit determines that the remaining storage capacity of the storage medium of the copying destination is small, and a copying operation cannot be performed, only a printing operation is performed.

19. The device according to claim 17, wherein
when said detection unit determines that the remaining storage capacity of the storage medium of the copying destination is small, and a copying operation cannot be performed, a warning that no copy is made is issued, and only a printing operation is performed.

20. The device according to claim 16, further comprising:
a display device capable of displaying the selected mode and image information; and
a detection unit detecting a remaining storage capacity of a storage medium of a copying destination when the continuous drive mode is specified by said continuous drive mode specification portion,

21. The device according to claim 20, wherein
when said detection unit determines as a detection result that the remaining storage capacity of the storage medium of the copying destination is small and a copying operation cannot be performed, said display device displays a warning that no copy is made, and only a printing operation is performed.

22. A printer device capable of installing a plurality of storage media, comprising:
a first selection portion for selecting a first storage medium from a plurality of installed storage media;
a second selection portion for selecting predetermined image information from image information stored in the selected first storage medium;
copying means for copying the predetermined image information selected by said second selection portion to a second storage medium different from the first storage medium;
printing means for printing predetermined image information selected by said second selection portion; and
a continuous drive mode specification portion capable of specifying a continuous drive mode in which an operation of copying the predetermined image information to the second storage medium and an operation of printing the same image information can be continuously performed.
